(19) United States
(12) Patent Application Publication
(10) Pub. No.: US 2014/0362613 A1
(43) Pub. Date: Dec. 11, 2014

(54) LC SNUBBER CIRCUIT

(71) Applicant: ABB Research Ltd, Zurich (CH)

(72) Inventors: Ki-Bum PARK, Fislisbach (CH); Francisco CANALES, Baden-Dattwil (CH); Sami PETTERSSON, Wettingen (CH)

(21) Appl. No.: 14/302,196

(22) Filed: Jun. 11, 2014

(30) Foreign Application Priority Data
Jun. 11, 2013 (EP) 13171354.7

(51) Int. Cl. H02M 1/34; H02M 3/335

(52) U.S. Cl. CPC H02M 1/34; H02M 3/33523; H02M 2001/346
USPC 363/21.16; 363/56.12

(57) ABSTRACT

The present disclosure relates to an LC snubber circuit for a switching converter, wherein the switching converter includes an inductor and a switching device connected in series. The LC snubber circuit can include a first snubber diode, a snubber capacitor, a second snubber diode, and a snubber transformer having a primary winding and a secondary winding. The secondary winding of the snubber transformer is connected to an output of the switching converter.

### RELATED APPLICATION

This application claims priority under 35 U.S.C. §119 to European Patent Application No. 13171354.7 filed in Europe on Jun. 11, 2013, the entire content of which is hereby incorporated by reference in its entirety.

### FIELD

The present disclosure relates to LC snubber circuits, and for example to minimising circulating currents in an LC snubber circuit.

### BACKGROUND INFORMATION

A variety of voltage snubber circuits have been developed for guaranteeing a voltage stress margin of semiconductors in switching converters. An RCD snubber is widely used in cost-sensitive applications, but it may cause rather large power losses. See, for example, [1] H.-S. Choi, “AN4137—Design guidelines for off-line flyback converters using Fairchild Power Switch (FPS)”, Fairchild Semiconductor Cor., 2003; and [2] S. Buonomo, F. Saya, and G. Vitale, “AN1889—STCO3DE170 in 3-phase auxiliary power supply,” STMicroelectronics, 2003.

An LC snubber may provide an alternative solution for reducing power losses in efficiency-sensitive applications. See, for example, [3] U.S. Pat. No. 5,260,607 (A) Nov. 9, 1993, K. Yoshihide, Snubber circuit for power converter; [4] U.S. Pat. No. 5,633,579 (A) May 27, 1997, M. G. Kim, Boost converter using an energy reproducing snubber circuit; [5] T. Ninomiya, T. Tanaka, and K. Harada, “Analysis and optimization of a nondissipative LC turn-off snubber,” IEEE Trans. Power Electronics, vol. 3, no. 2, April 1988; [6] U.S. Pat. No. 6,115,271 (A) Sep. 5, 2009, C. H. S. Mo, Switching power converters with improved lossless snubber networks; [7] C.-S. Liao and K. M. Smedley, “Design of high efficiency flyback converter with energy regenerative snubber,” in Proc. IEEE APEC 2008, pp. 797-800; [8] K. I. Hwu, Y. T. Yau, and L.-L. Lee, “Powering LED using high-efficiency SR flyback converter,” IEEE Trans. Industry Applications, vol. 47, no. 1, January/February 2011; and [9] TW201119201 (A) Jun. 1, 2011, R. L. Lin and Y. H. Huang, Forward-flyback converter with lossless snubber circuit. FIGS. 1a to 1c show some implementations of known LC snubbers. FIG. 1ashows an LC snubber 11 in a flyback converter. FIG. 1b shows an LC snubber 12 in a forward converter. FIG. 1c shows an LC snubber 13 in a current-fed converter.

The flyback converter topology, such as that shown in FIG. 1a, is a popular topology for low power applications due to its simple structure having one switch Q, one diode Dₒ, and a transformer T. See, for example, [1] H.-S. Choi, “AN4137—Design guidelines for off-line flyback converters using Fairchild Power Switch (FPS)”, Fairchild Semiconductor Cor., 2003. At the cost of the simple structure, however, the flyback may suffer from a large voltage/current stress on the switch Q and the diode Dₒ. Moreover, a leakage inductance of the main transformer T can cause a considerable voltage spike at turn-off of the switch Q. As a result, use of a voltage snubber may be appropriate, as shown in FIG. 1a, for example.

The voltage stress margin of the switching device in the switching converter may be very limited in some high supply voltage applications, such as a three-phase auxiliary power supply (APS), where the supply voltage may reach 1200 V. Thus, the snubber may have to be able to limit additional voltage stress to a small range. See, for example, [2] S. Buonomo, F. Saya, and G. Vitale, “AN1889—STCO3DE170 in 3-phase auxiliary power supply,” STMicroelectronics, 2003. In this case, the snubber capacitance in the LC snubber can be increased, which may, in return, result in higher circulating currents. These circulating currents may induce additional conduction losses in the switch and in the snubber circuit itself. Some of the developed LC snubbers may improve the performance. See, for example, [7] C.-S. Liao and K. M. Smedley, “Design of high efficiency flyback converter with energy regenerative snubber,” in Proc. IEEE APEC 2008, pp. 797-800; [8] K. I. Hwu, Y. T. Yau, and L.-L. Lee, “Powering LED using high-efficiency SR flyback converter,” IEEE Trans. Industry Applications, vol. 47, no. 1, January/February 2011; and [9] TW201119201 (A) Jun. 1, 2011, R. L. Lin and Y. H. Huang, Forward-flyback converter with lossless snubber circuit, but they are only limited to a narrow supply voltage range.

### SUMMARY

An LC snubber circuit is disclosed for connection with a switching converter having a first converter inductor connected between a first connection node and a second connection node, and a first converter switching device connected between the second connection node and a third connection node, wherein the LC snubber circuit comprises: a first snubber diode connected to a fourth connection node, for connection between the fourth connection node and a first connection node; a snubber capacitor connected to the fourth connection node, for connection between a second connection node and the fourth connection node; a second snubber diode and a snubber transformer having a primary winding and a secondary winding, wherein the primary winding and second snubber diode are connected in series to the fourth connection node, for connection between a third connection node and the fourth connection node; and rectifying means connected to the secondary winding of the snubber transformer for connecting the secondary winding to an output of the switching converter.

A method is also disclosed for a switching converter having a first converter inductor connected between a first connection node and a second connection node, and a first converter switching device connected between the second connection node and a third connection node, wherein the method comprises: using an LC snubber for limiting a maximum voltage stress of the first converter switching device; and transferring energy stored in the LC snubber to an output through a snubber transformer coupled with the output in order to reduce circulating currents in the LC snubber.

### BRIEF DESCRIPTION OF THE DRAWINGS

In the following, features disclosed herein will be described in greater detail by way of preferred exemplary embodiments with reference to the attached drawings, in which:

FIGS. 1a to 1c show some implementations of known LC snubbers;

FIGS. 2a to 2c show exemplary voltage and current waveforms of a known LC snubber;

FIGS. 3a to 3e show current paths of a known LC snubber;

FIGS. 4a to 4e illustrate an exemplary implementation of the disclosed enhanced LC snubber topology;

FIG. 5 shows exemplary implementation of the enhanced LC snubber circuit in a flyback converter;

FIGS. 6a to 6d show exemplary voltage and current waveforms of the enhanced LC snubber of FIG. 5;

FIGS. 7a to 7d show current paths in the enhanced LC snubber of FIG. 5;

FIGS. 8a to 8d show exemplary, simulated current and voltage waveforms of a known LC snubber; and

FIGS. 9a to 9d show exemplary, simulated current and voltage waveforms of an enhanced LC snubber.

### DETAILED DESCRIPTION

A method and an apparatus are disclosed for implementing the method so as to alleviate disadvantages discussed herein.

The present disclosure presents an enhanced LC snubber topology for a switching converter. The enhanced LC snubber can reduce circulating current compared with known LC snubbers. The proposed snubber has a coupling to the output of the switching converter through which energy stored in the snubber can be transferred to the output, which can minimise the circulating currents. This may lead to higher efficiency. The coupling to the output may be implemented by a transformer having its primary winding operating as the snubber inductance.

The disclosed LC snubber can provide an effective voltage clamping for the switch(es) of the switching converter. The peak voltage stress for the switch(es) can be reduced. This leads to lower switch voltage stress and higher reliability. The effective voltage clamping may also provide room for increased duty ratio, thereby further reducing conduction losses.

The current ripple of the output capacitor can be reduced as a portion of the power is transferred through the snubber during the on-state of the switch. As the ripple is reduced, the size of the output filter of the switching converter can also be reduced.

The disclosed enhanced LC snubber can be applied to various types of converter topologies and implemented with different types of secondary stages of the enhanced LC snubber.

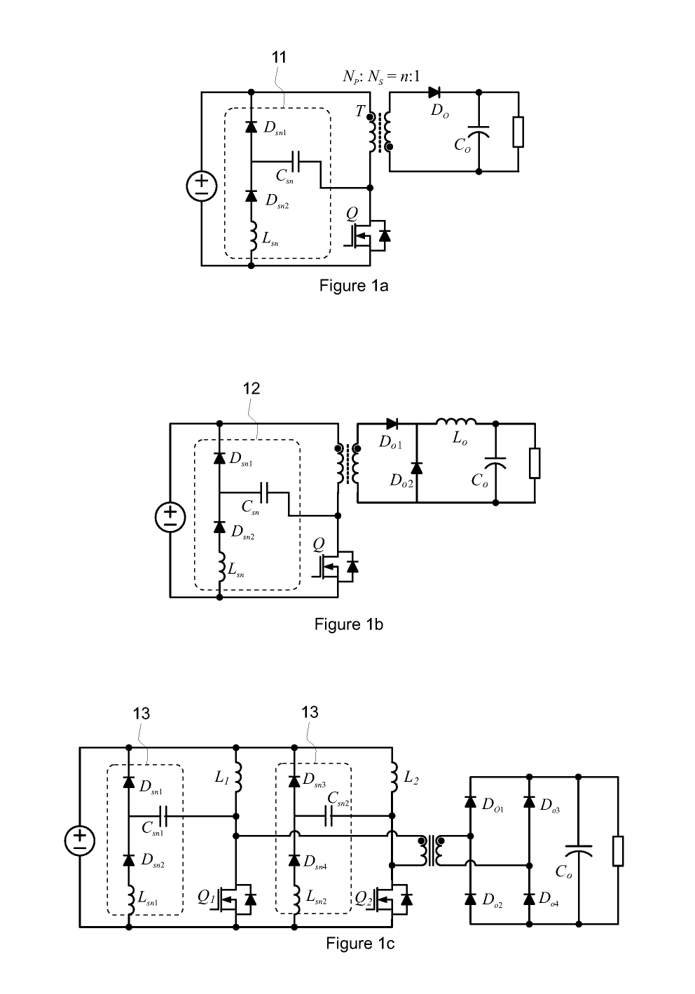

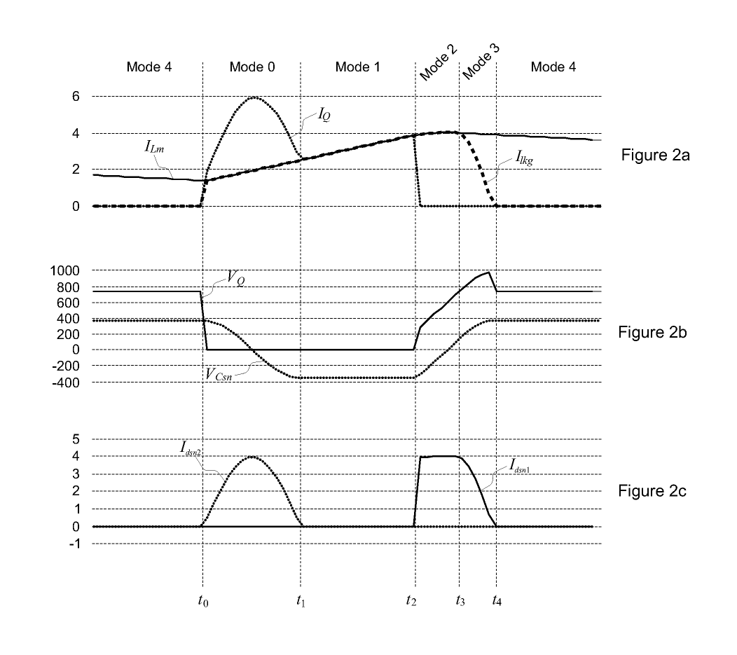

An operation principle of a known LC snubber installed in a flyback converter, such as that illustrated in FIG. 1 a, is next discussed in more detail. The circulating current inducing additional conduction losses is also investigated. FIGS. 2a to 2c show exemplary voltage and current waveforms of the snubber shown in FIG. 1a. A magnetising current I_{Lm} and a leakage current I_{lkg} of the transformer T, and a current I_{Q} through the switching device Q are shown in FIG. 2a; a voltage V_{Q} over the switching device Q and a voltage V_{Csn} over a snubber capacitor Cₛₙ are shown in FIG. 2b; currents I_{Dsn2} and I_{Dsn2} through snubber diodes Dₛₙ₁ and Dₛₙ₂ are shown in FIG. 2c.

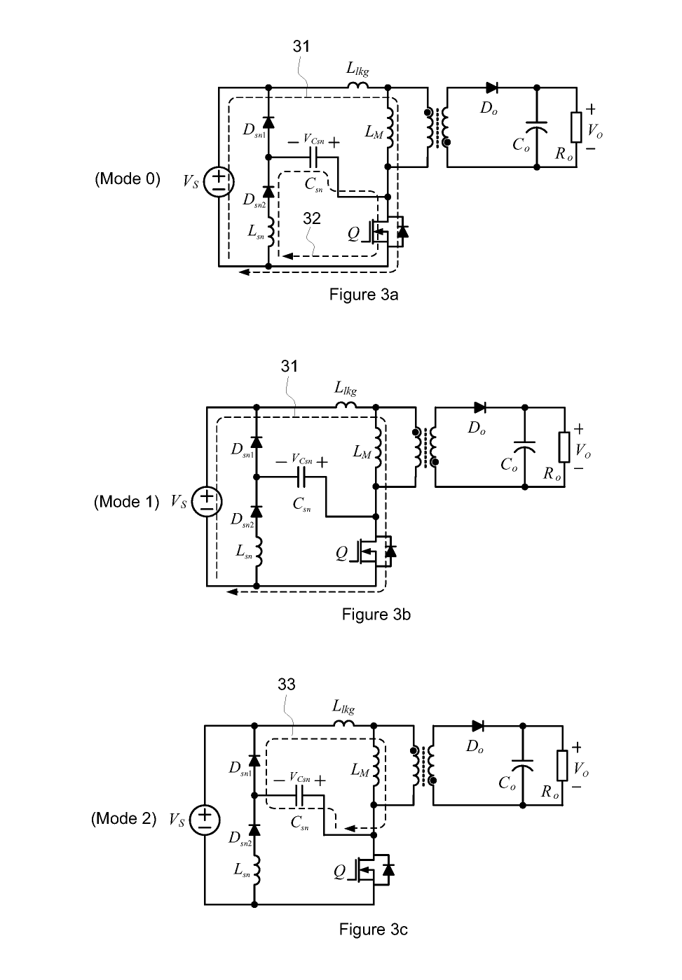

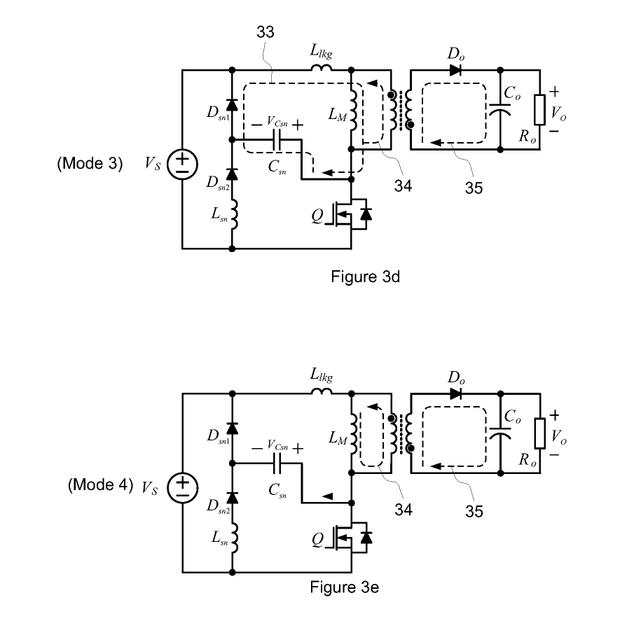

FIGS. 3a to 3e show current paths of the LC snubber of FIG. 1a. For the sake of circuit analysis, the main transformer has been replaced with an exemplary equivalent circuit having an ideal transformer, a magnetising inductance Lₘ and a leakage inductance L_{lkg} in FIGS. 3a to 3e.

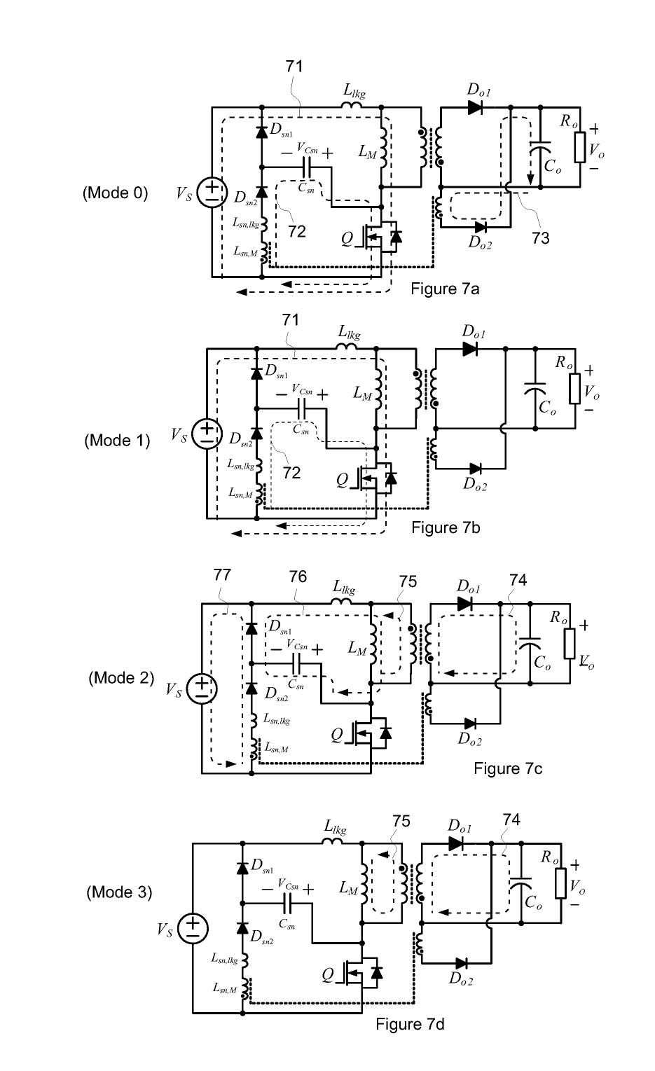

The operation of the snubber in FIG. 1a can be divided into five modes. At instant t₀ in FIGS. 2a to 2c, the switch Q is turned on and the supply voltage V_{S} is applied to the transformer primary side, and thus, the snubber enters Mode 0. The magnetising current I_{Lm} of the transformer starts to flow through Q on path 31 as shown in FIG. 7a. At the same time, the snubber capacitor Cₛₙ and the snubber inductor Lₛₙ form a first resonant circuit and a sinusoidal current induced by the resonant operation starts to flow through Q on path 32 as shown in FIG. 7a. The sinusoidal current passing through the snubber inductor Lₛₙ can be calculated as follows:

$${I}_{Lsn} ( t ) = {V}_{Csn , peak} \sqrt{\frac{{C}_{sn}}{{L}_{sn}}} sin ( {ω}_{1} ( t - {t}_{0} ) ) , \qquad ( 1 )$$

where ω₁ is the resonant frequency of the first resonant circuit and V_{Csn,peak} is the (positive) peak voltage over the snubber capacitor Cₛₙ. The (positive) peak voltage can be calculated as follows:

V_{Csn,peak}=ΔV_{Q}+nV_{O}, (2)

where ΔV_{Q} is the the additional voltage stress over the switch Q, and V_{O} is the output voltage of the switching converter; n is the transformation ratio of the transformer T. The resonant frequency ω₁ can be calculated as follows:

$${ω}_{1} = \frac{1}{\sqrt{{L}_{sn} {C}_{sn}}} .$$

FIG. 2c shows the sinusoidal shape of the second snubber diode current between instants t₀ and t₁.

At instant t₁ in FIG. 2c, the second snubber current I_{Dsn2} reaches zero, and the snubber circuit enters Mode 1. As also shown in FIG. 2a, only the magnetising current I_{Lm} flows through the switch Q.

At instant t₂, the switch Q is turned off and the snubber enters Mode 2. As the switch is no longer conducting, the first snubber diode Dₛₙ₁ starts to conduct conducting and magnetising current I_{Lm} charges the snubber capacitor Cₛₙ. FIG. 3c shows a new path 33 of the magnetising current I_{Lm}. As shown in FIG. 2b, the snubber capacitor voltage V_{Csn} increases and the switch voltage V_{Q} increases accordingly.

At instant t₃, the snubber enters Mode 3. The switch voltage V_{Q} reaches V_{S}+nV_{O}, i.e. the steady-state voltage stress on Q, and the magnetising current starts to flow through a primary winding of the ideal transformer (on path 34 on FIG. 3d). The output diode D_{O} of the converter starts to conduct and charge the output capacitor C_{O} (through path 35 in FIG. 3d). At the same time, the energy stored in the leakage inductance L_{lkg} charges the snubber capacitor Cₛₙ through path 33, and thus the switch voltage V_{Q} starts to rise above the steady-state voltage stress V_{S}+nV_{O}. The leakage current I_{lkg} decreases as the switching device voltage V_{Q} increases first. The leakage current I_{lkg} can be defined as follows:

I_{lkg}(t)=I_{Q,peak}{1−cos(ω₂(t−t₃))}. (3)

where ω₂ is the resonance frequency of the second resonance circuit and can be defined as follows:

$${ω}_{2} = \frac{1}{\sqrt{{L}_{lkg} {C}_{sn}}} .$$

The switching device voltage V_{Q} can be calculated as follows:

$${V}_{Q} ( t ) = {V}_{S} + {nV}_{O} + {I}_{Q , peak} \sqrt{\frac{{L}_{lkg}}{{C}_{sn}}} sin ( {ω}_{2} ( t - {t}_{3} ) ) , \qquad ( 4 )$$

where I_{Q,peak} is the peak current through the switching device Q, i.e. the current I_{Q}(t₃) through the switching device Q at instant t₃.

At instant t₄ in FIG. 2a, I_{lkg} reaches zero. In FIG. 2b, V_{Q} reaches the maximum voltage and decreases then to the steady-state voltage stress level again. The snubber enters Mode 4, in which the switch remains in a non-conducting state. The magnetizing current still charges the output capacitor C_{O} through paths 34 and 35.

Then the switching device Q is turned on again and the whole cycle is repeated starting from Mode 0.

An additional voltage stress ΔV_{Q} can be seen on top of the steady-state voltage stress V_{S}+nV_{O} in FIG. 2b (between instants t₃ and t₄). The level of the additional voltage stress ΔV_{Q} depends on how the snubber is implemented. On the basis of Equation 4, the additional voltage stress can be defined as follows:

$$Δ {V}_{Q} = {I}_{Q , peak} \sqrt{\frac{{L}_{lkg}}{{C}_{sn}}} . \qquad ( 5 )$$

In order to guarantee that the maximum voltage stress of the switch remains within a desired margin, a maximum level for the additional voltage stress ΔV_{Q} may be determined first. Then the snubber capacitor Cₛₙ capacitance can be determined for given values of I_{Q,peak} and L_{lkg} on the basis of Equation 5:

$${C}_{sn} = \frac{{L}_{lkg} {I}_{Q , peak}^{2}}{Δ {V}_{Q}^{2}} . \qquad ( 6 )$$

The circulating current(s) induced in the snubber of FIG. 1a is (are) proportional to Cₛₙ and can be expressed as follows:

$$\begin{matrix}{I}_{Dsn 1 , avg} = {I}_{Dsn 2 , avg} \\ = {I}_{Lsn , avg} \\ = 2 {V}_{Csn , peak} {C}_{sn} {F}_{s} \\ = 2 ( {I}_{Q , peak} \sqrt{{L}_{lkg} {C}_{sn}} + {nV}_{O} {C}_{sn} ) {F}_{s} ,\end{matrix} \qquad ( 7 )$$

where Fₛ is the switching frequency of the switching converter.

As shown in Equations 6 and 7, the circulating current increases as the additional voltage stress ΔV_{Q} reduces. This circulating current may vary depending on the application and the design. For example, if the switch voltage stress margin is small, as in APS applications, a large snubber capacitor Cₛₙ may be used. As a result, a larger circulating current is induced in the snubber, which may result in higher conduction losses. For example, FIGS. 2a to 2c represent waveforms of a switching converter designed according to an APS specification. As shown in FIGS. 2a and 2c, the total circulating current I_{Dsn1}+I_{Dsn2} forms a large portion of the current I_{lkg} that transfers energy.

The present disclosure discloses an LC snubber circuit for a switching converter which can reduce the circulating currents. In order to reduce the circulating currents within the snubber circuitry, the disclosed enhanced LC snubber transfers the energy stored in the snubber to the output side of the switching converter. The disclosed enhanced LC snubber topology is applicable to a variety of switching converters. For example, it may be used in a switching converter which can include a series connection of an inductance and a switching device used for producing an output voltage.

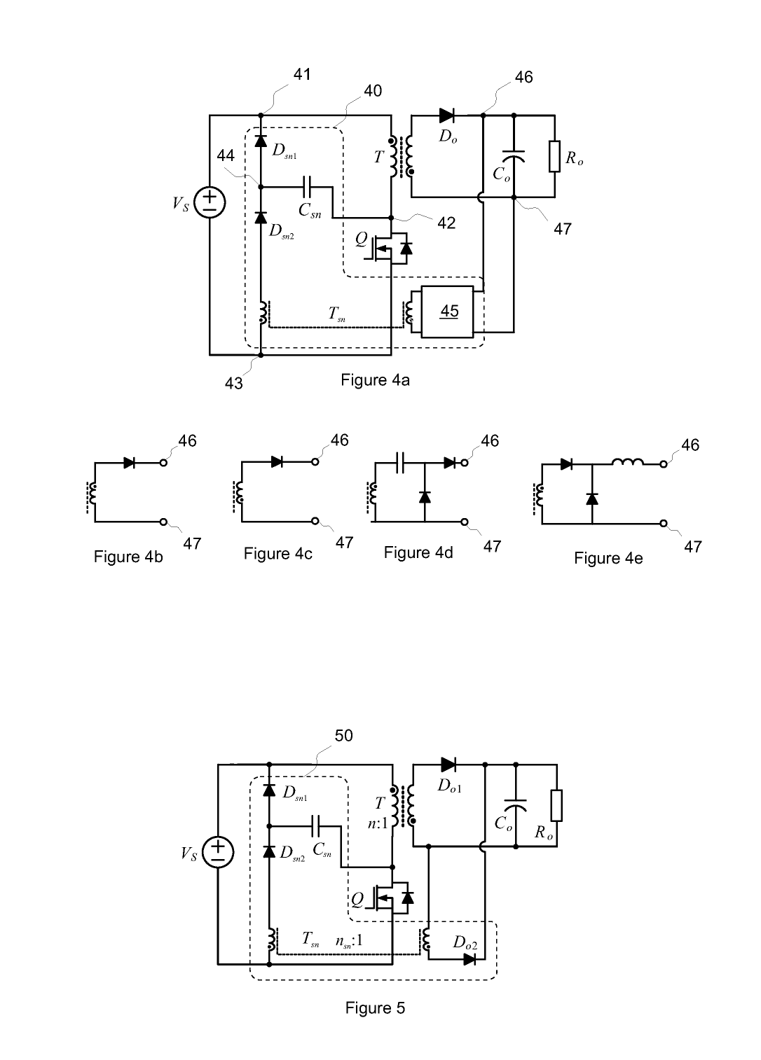

FIGS. 4a to 4e illustrate an exemplary implementation of the disclosed enhanced LC snubber topology. FIG. 4a illustrates an exemplary switching converter having the disclosed enhanced LC snubber topology. The LC snubber 40 of FIG. 4a can be used for limiting the maximum voltage stress of a main switching device of the switching converter.

In FIG. 4a, the switching converter is an isolated switching converter in the form of a flyback converter. A series connection is formed by a first converter inductor connected between a first connection node 41 and a second connection node 42, and a first converter switching device Q connected between the second connection node 42 and a third connection node 43. The series connection is supplied with a supply voltage V_{S}.

In FIG. 4a, the first converter inductor is in the form of a primary winding of a main transformer T. The series connection of the main transformer T primary winding and the switching device Q is connected between outputs of a voltage supply V_{S}. The secondary winding of the main transformer Tis connected to an output capacitor through an output diode D_{O}. The switching device Q in FIG. 4a is an N-channel depletion MOSFET. The switching device Q is configured to control a flow of current in the direction from the second connection node 42 to the third connection node 43.

The basic structure of the enhanced LC snubber 40 in FIG. 4a is similar to that of a known LC snubbers. However, the enhanced LC snubber circuit 40 can include a first snubber diode Dₛₙ₁ connected between a fourth connection node 44 and the first connection node 41, and a snubber capacitor Cₛₙ connected between the second connection point 42 and the fourth connection point 44.

In the snubber 40, energy stored in the snubber is transferred to the output through a snubber transformer Tₛₙ coupled to the output of the switching converter in order to minimise circulating currents in the snubber 40. The disclosed snubber topology can include a second snubber diode Dₛₙ₂ and a snubber transformer Tₛₙ having a primary winding and a secondary winding. The primary winding and second snubber diode Dₛₙ₂ are connected in series between the third connection node 43 and the fourth connection node 44. FIG. 4a shows the snubber transformer Tₛₙ having subtractive polarity.

On a path between the second connection node 42 and the fourth connection node 44 and through the third connection node 43, the second snubber diode Dₛₙ₂ is forward-biased in the direction in which the switching device Q is configured to control the flow of current.

The first snubber diode Dₛₙ₁ is forward-biased in the same direction as the second snubber diode Dₛₙ₂on a path between the first connection node 41 and the third connection node 43 through the fourth connection node 44.

In order to transfer the energy stored in the snubber capacitor Cₛₙ to the output, the snubber circuit 40 can include rectifying means 45 connecting the secondary winding of the snubber transformer Tₛₙ to an output of the switching converter. In FIG. 4a, the rectifying means are connected between two output connection nodes 46 and 47 at the poles of the output capacitor. The rectifying means may for example, include filtering means, such as a filter for filtering the rectified current. FIGS. 4b to 4e illustrate exemplary implementations of rectifying means suitable for the disclosed enhanced LC snubber. FIG. 4b shows a single diode rectifier; FIG. 4c shows a single diode rectifier with an opposite dot (i.e. a snubber transformer with additive polarity) for a flyback converter operation; FIG. 4d shows a voltage-doubler type rectifier; FIG. 4e shows rectifying means with an inductive filter for forward converter operation. Further, a center-tap type or a full-bridge type rectifier may be used, for example.

The snubber 40 in FIG. 4a can be considered as a small isolated DC-DC converter which transfers power from Cₛₙ to the output, sharing the switch with the main converter. This additional power transfer process allows circulating current, which can cause large conduction losses in the snubber circuit, to be minimised.

Use of the disclosed snubber topology is not limited to the flyback converter shown in FIG. 4a. Other switching converter topologies and/or other types of inductances and/or switching devices may be used. The switching device may be a MOSFET or an IGBT, for example. The switching converter may also be supplied by a negative supply voltage.

FIG. 5 shows an exemplary implementation of the disclosed enhanced LC snubber topology in a flyback converter. The LC snubber 50 in FIG. 5 can limit the additional voltage stress while maintaining the circulating currents at a reduced level.

In FIG. 5, the rectifying means for coupling the secondary winding of the snubber transformer Tₛₙ are formed by a secondary output diode Dₒ₂, which connects the snubber transformer Tₛₙ secondary winding to the output of the switching converter. FIG. 5 shows the snubber transformer Tₛₙ having subtractive polarity.

The snubber 50 in FIG. 5 utilises the resonance between the leakage inductance L_{sn,lkg} of the snubber transformer Tₛₙ and the snubber capacitor Cₛₙ. The leakage inductance L_{sn,lkg} of the snubber transformer Tₛₙ primary winding, the second snubber diode Dₛₙ₂, the snubber capacitor Cₛₙ and the first switching device Q form a resonance circuit.

Since L_{sn,lkg} is small compared with a snubber inductance of known LC snubbers, the snubber capacitor Cₛₙ may have to be larger in order to maintain the resonant frequency and to reduce the peak current of the snubber. As a result, the snubber capacitor voltage V_{csn} maintains almost a constant value (i.e., substantially constant, such as ±10%), which can also help reduce the switch voltage stress.

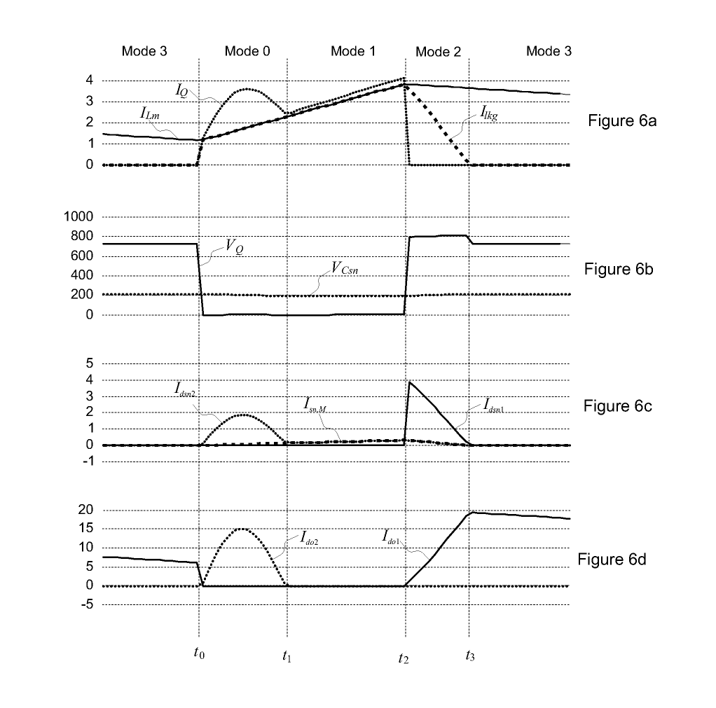

FIGS. 6a to 6d show exemplary voltage and current waveforms of the snubber of FIG. 5. Four exemplary modes of operation are shown in FIGS. 6a to 6d. The magnetising current I_{Lm} and the leakage current I_{lkg} of the transformer T, and a current I_{Q} through the switching device Q are shown in FIG. 6a; the voltage V_{Q} over the switching device Q and the voltage V_{Csn} over the snubber capacitor Cₛₙ are shown in FIG. 6b; the currents I_{Dsn1} and I_{Dsn2} through the snubber diodes Dₛₙ₁ and Dₛₙ₂ are shown in FIG. 6c; currents I_{Do1} and I_{Do2} through the output diodes D_{O1} and D_{O2} are shown in FIG. 6d;

FIGS. 7a to 7d show exemplary snubber current paths in the LC snubber during each of the modes. For the circuit analysis, the main transformer is represented by an equivalent circuit having an ideal transformer, a magnetising inductance Lₘ, and a leakage inductance L_{lkg} in FIGS. 7a to 7d. The snubber transformer is represented with a snubber magnetising inductance L_{sn,M}, and a snubber leakage inductance L_{sn,lkg}. The switching converter is supplied with a supply voltage V_{S} of 600 V. The voltage over the snubber capacitor Cₛₙ is represented by the reference V_{Csn}.

At instant t₀ in FIGS. 6a to 6d, the switch Q is turned on and the magnetising current I_{Lm} starts to flow through the switching device Q; Mode 0 starts. FIG. 7a illustrates the path 71 of magnetising current I_{Lm}. At the same time, the snubber capacitor Cₛₙ and the snubber leakage inductance L_{sn,lkg} form a resonant circuit 72, and an energy transfer path 73 from Cₛₙ to the output is formed through the snubber transformer. Thus, the energy stored in Cₛₙ is transferred to the output. In Mode 0, the current of the resonant circuit can be defined as a current I_{Lsn,lkg} through the snubber capacitor leakage inductance:

$${I}_{Lsn , lkg} ( t ) = ( {V}_{Csn , max} - {n}_{sn} {V}_{O} ) \sqrt{\frac{{C}_{sn}}{{L}_{sn , lkg}}} sin ( {ω}_{3} ( t - {t}_{0} ) ) , \qquad ( 8 )$$

where V_{Csn,max} is the maximum value of the snubber capacitor voltage; V_{O} is the output voltage; nₛₙ is the turns ratio of the snubber transformer; ω₃ is the resonance frequency of the resonance circuit which can be defined as follows:

$${ω}_{3} = \frac{1}{\sqrt{{L}_{sn , lkg} {C}_{sn}}} .$$

As shown in FIGS. 6a and 6c, the resonant operation ends at instant t₁. The enhanced LC snubber enters Mode 1. FIG. 6c shows that a relatively small magnetising current I_{Lsn,M} of the snubber transformer still flows. FIG. 7b shows path 72 of the snubber transformer magnetising current I_{Lsn,M}. The magnetising current I_{Lm} of the main transformer still flows on path 71.

At instant t₂, the switching device Q is turned off. The snubber circuit enters Mode 2. FIG. 6b shows a sharp rise in the voltage V_{Q} of the switching device Q. The first snubber diode Dₛₙ₁ is conducting and the voltage V_{Q} is clamped to V_{S}+V_{Csn}. The output diode D_{O1} is also conducting and an energy transfer path 74 to the output through the main transformer is formed. The magnetising current I_{Lm} of the main transformer starts to flow on path 75.

The leakage inductance current I_{lkg} flows to the snubber capacitor Cₛₙ; i.e. the energy stored in the leakage inductance L_{lkg} is transferred to Cₛₙ. FIG. 7c shows path 76 of the leakage current L_{lkg}. The leakage inductance current I_{lkg} can be defined as follows:

$${I}_{lkg} ( t ) = {I}_{Q , peak} - \frac{{V}_{Csn , avg} - {nV}_{O}}{{L}_{lkg}} ( t - {t}_{2} ) , \qquad ( 9 )$$

where V_{Csn,avg} is the average voltage of the snubber capacitor Cₛₙ. The magnetising current I_{Lsn,M} of the snubber transformer flows back to the input side on a path 77 through the snubber diodes Dₛₙ₁ and Dₛₙ₂, which guarantees that the snubber transformer resets.

At instant t₃, the current I_{lkg} through the leakage inductance of the main transformer reaches zero, as also shown in FIG. 6a. The snubber circuit enters Mode 3. The switch remains in a stable non-conducting state. The output diode D_{O1} is conducting, and the magnetising current I_{Lm} of the main transformer flows to the output via paths 74 and 75.

Then, the switching device Q is turned on again and the whole cycle is repeated starting from Mode 0.

The voltage/current stresses in the enhanced LC snubber circuit can be obtained according to following Equations 10 to 14. The effect of the magnetising inductance L_{sn,M} of the snubber transformer Tₛₙ has been ignored. As the turns ratio nₛₙ of the snubber transformer Tₛₙ decreases, the additional voltage stress ΔV_{Q} decreases but the snubber currents increase. That is, a larger portion of the total power is transferred to the output through the snubber. In order to minimise the total conduction losses while guaranteeing the switch voltage stress margin, the turns ratio nₛₙ of the snubber transformer may have to be carefully selected.

$$\begin{matrix}{V}_{Csn , avg} = {n}_{sn} {V}_{O} , & ( 10 ) \\ Δ {V}_{Q} = ( {n}_{sn} - n ) {V}_{O} , & ( 11 ) \\ Δ {V}_{Csn} = \frac{{I}_{Q , peak}^{2} {L}_{lkg}}{2 ( 1 - n / {n}_{sn} ) {V}_{O} {C}_{sn}} , & ( 12 ) \\ {I}_{Dsn 1 , avg} = {I}_{Dsn 2 , avg} = {I}_{Lsn , avg} = \frac{{I}_{Q , peak}^{2} {L}_{lkg}}{2 ( {n}_{sn} - n ) {V}_{O} {T}_{S}} , and & ( 13 ) \\ {I}_{Do 1 , avg} = \frac{{I}_{Q , peak}^{2} {L}_{lkg}}{2 ( 1 - n / {n}_{sn} ) {V}_{O} {T}_{S}} , & ( 14 )\end{matrix}$$

where T_{S} is the length of the switching cycle (=1/F_{S}).

The performance of the disclosed enhanced snubber was verified by computer simulations. The flyback converter with the enhanced LC snubber circuit as shown in FIG. 5 was simulated, and the simulation was compared with a simulation of the conventional LC snubber of FIG. 1a.

The simulated flyback converter was designed according to an APS specification, the supply voltage being in the range of 300 to 1200 V. Additional voltage stress on the switch was relatively small since only a few suitable switching devices were available, such as a 1500-V Si MOSFET or a 1700-V SiC JFET/MOSFET. Thus, the snubbers limiting the additional voltage stress were heavily burdened, which made the design of the snubbers even more important in terms of efficiency.

The design parameters for the simulations were selected for an exemplary 1700-V switch. In both simulations, the supply voltage V_{S} of the flyback converter was 1000 V; the output voltage V_{O} was 24 V; the output power P_{O} was 260 W; and the switching frequency F_{S} was 60 kHz. The turns ratio N_{P}:N_{S} of the main transformer used in the simulations was 16:3; the magnetising inductance L_{M} of the main transformer was 700 μH; and the leakage inductance L_{lkg} was 20 μH.

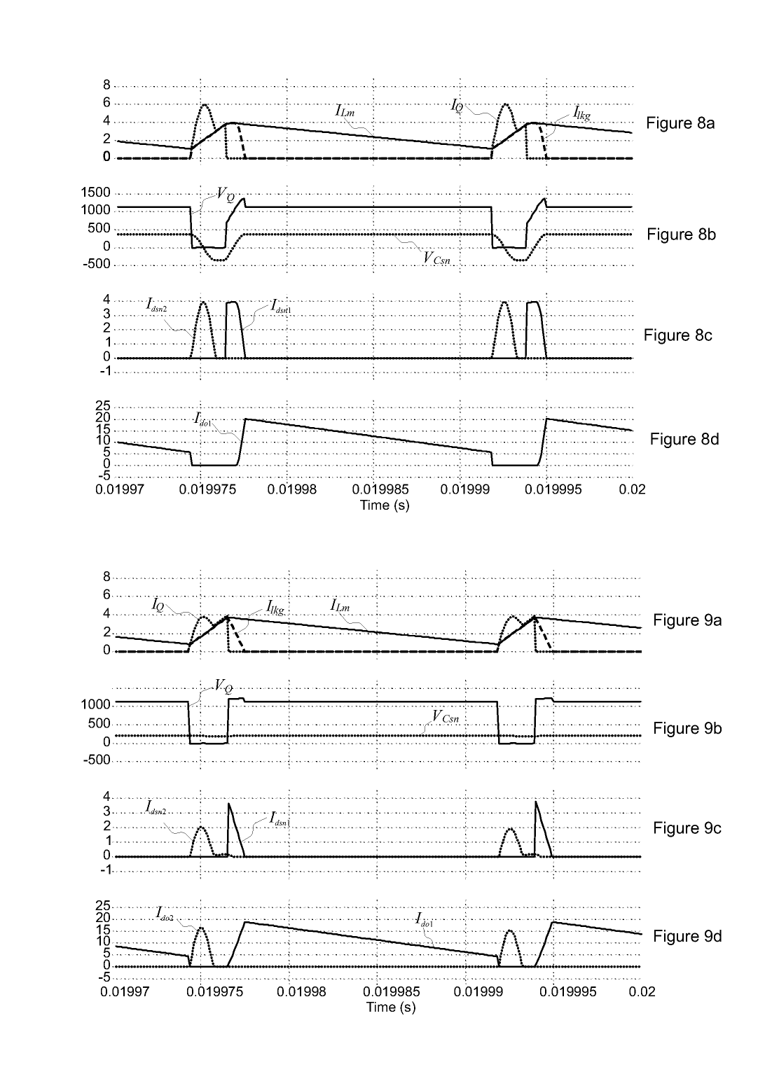

In the simulations of the known LC snubber, the snubber inductor Lₛₙ had an inductance of 40 μH; and the snubber capacitor Cₛₙ had a capacitance of 5 nF. FIGS. 8a to 8d show simulated current and voltage waveforms of the known LC snubber.

In the simulations of the enhanced LC snubber, the snubber transformer primary winding had a leakage inductance L_{sn,lkg} of 2 μH; and the snubber capacitor Cₛₙ had a capacitance of 100 nF. The turns ratio N_{P,sn}:N_{S,sn} of the snubber transformer used in the simulations was 25:3. FIGS. 9a to 9d show simulated current and voltage waveforms of the enhanced LC snubber.

FIGS. 8a and 9a show the magnetising current I_{Lm} the leakage current I_{lkg}, and the current I_{Q} of the switching device Q; FIGS. 8b and 9b show the voltage V_{Q} over the switching device Q and the snubber capacitor voltage V_{Csn}; FIGS. 8c and 9c show the snubber diode currents I_{Dsn1} and I_{Dsn2}; FIGS. 8d and 9d show the first output diode current I_{Do1}, and in FIG. 9d, the second output diode current I_{Do2}. Comparison of the simulated current/voltage stresses is given in Table 1.

TABLE 1
Comparison of simulated current/voltage stresses

| | Known | | Enhanced | |
|---|---|---|---|---|
| | LC snubber | | LC snubber | |
| I_{lkg,avg} | 0.486 | A | 0.388 | A |
| I_{lkg,rms} | 1.224 | A | 1 | A |
| I_{Q,avg} | 0.484 | A | 0.386 | A |
| I_{Q,rms} | 1.49 | A | 1.133 | A |
| I_{Dsn1,avg} | 0.206 | A | 0.112 | A |
| I_{Dsn1,rms} | 0.861 | A | 0.546 | A |
| I_{Dsn2,avg} | 0.204 | A | 0.11 | A |
| I_{Dsn2,rms} | 0.796 | A | 0.4 | A |
| I_{Do1,avg} | 10.9 | A | 10.11 | A |
| I_{Do1,rms} | 12.5 | A | 11.5 | A |
| I_{Do2,avg} | — | | 0.79 | A |
| I_{Do2,rms} | — | | 3.18 | A |
| I_{Co,rms} | 6.11 | A | 4.93 | A |
| V_{Q,peak} | 1370 | V | 1214 | V |
| V_{Csn,peak} | 370 | V | 214 | V |

As shown in Table 1, the simulated snubber currents I_{Dsn1} and I_{Dsn2} were reduced by about a half in the simulated enhanced LC snubber, which led to reduced I_{lkg} and I_{Q}. Therefore, smaller conduction losses could be achieved with the enhanced LC snubber. The peak switch voltage stress was also reduced from 1370 V down to 1214 V. Such reduction may improve the reliability of the flyback converter. In addition, the smaller voltage stress provides design flexibility to further increase the duty ratio, which may be used to further reduce the conduction losses.

The simulated enhanced snubber transferred a portion of the power through Dₒ₂ during the on-state of the switch Q. Thus, the ripple current of the output capacitors was reduced. A smaller ripple allows use of a smaller output capacitor.

It will be apparent to a person skilled in the art that the inventive concept can be implemented in various ways. The invention and its embodiments are not limited to the examples described above but may vary within the scope of the claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCES

[1] H.-S. Choi, “AN4137—Design guidelines for off-line flyback converters using Fairchild Power Switch (FPS)”, Fairchild Semiconductor Cor., 2003.
[2] S. Buonomo, F. Saya, and G. Vitale, “AN1889—STCO3DE170 in 3-phase auxiliary power supply,” STMicroelectronics, 2003.
[3] U.S. Pat. No. 5,260,607 (A) Nov. 9, 1993, K. Yoshihide, Snubber circuit for power converter.
[4] U.S. Pat. No. 5,633,579 (A) May 27, 1997, M. G. Kim, Boost converter using an energy reproducing snubber circuit.
[⁵] T. Ninomiya, T. Tanaka, and K. Harada, “Analysis and optimization of a nondissipative LC turn-off snubber,” IEEE Trans. Power Electronics, vol. 3, no. 2, April 1988.
[6] U.S. Pat. No. 6,115,271 (A) Sep. 5, 2009, C. H. S. Mo, Switching power converters with improved lossless snubber networks.
[7] C.-S. Liao and K. M. Smedley, “Design of high efficiency flyback converter with energy regenerative snubber,” in Proc. IEEE APEC 2008, pp. 797-800.
[8] K. I. Hwu, Y. T. Yau, and L.-L. Lee, “Powering LED using high-efficiency SR flyback converter,” IEEE Trans. Industry Applications, vol. 47, no. 1, January/February 2011.
[9] TW201119201 (A) Jun. 1, 2011, R. L. Lin and Y. H. Huang, Forward-flyback converter with lossless snubber circuit.

1. An LC snubber circuit for connection with a switching converter having a first converter inductor connected between a first connection node and a second connection node, and a first converter switching device connected between the second connection node and a third connection node, wherein the LC snubber circuit comprises:
a first snubber diode connected to a fourth connection node, for connection between the fourth connection node and a first connection node;
a snubber capacitor connected to the fourth connection node, for connection between a second connection node and the fourth connection node;
a second snubber diode and a snubber transformer having a primary winding and a secondary winding, wherein the primary winding and second snubber diode are connected in series to the fourth connection node, for connection between a third connection node and the fourth connection node; and
rectifying means connected to the secondary winding of the snubber transformer for connecting the secondary winding to an output of the switching converter.

2. An LC snubber circuit as claimed in claim 1, wherein the rectifying means comprise:
a diode for connecting the snubber transformer secondary winding to an output of the switching converter.

3. An LC snubber circuit as claimed in claim 1, wherein the snubber transformer has subtractive polarity.

4. A switching converter, comprising:
the LC snubber circuit as claimed in claim 1;
a first converter inductor connected between the first connection node and the second connection node; and
a first converter switching device connected between the second connection node and the third connection node, wherein the LC snubber circuit is connected to the first, second and third connection nodes.

5. A switching converter, as claimed in claim 4, wherein the switching converter is an isolated switching converter, and the first converter inductor is a primary winding of a main transformer of the switching converter.

6. A switching converter as claimed in claim 5, wherein the isolated switching converter is a flyback converter.

7. A method for a switching converter, having a first converter inductor connected between a first connection node and a second connection node, and a first converter switching device connected between the second connection node and a third connection node, wherein the method comprises:
using an LC snubber for limiting a maximum voltage stress of the first converter switching device; and
transferring energy stored in the LC snubber to an output through a snubber transformer coupled with the output in order to reduce circulating currents in the LC snubber.

8. A method as claimed in claim 7, wherein the LC snubber comprises:
a first snubber diode connected to a fourth connection node, for connection between the fourth connection node and the first connection node;
a snubber capacitor connected to the fourth connection node, for connecting between the second connection node and the fourth connection node;
a second snubber diode and a snubber transformer having a primary winding and a secondary winding, wherein the primary winding and second snubber diode are connected in series to the fourth connection node, for connection between the third connection node and the fourth connection node; and
rectifying means connected to the secondary winding of the snubber transformer for connecting the secondary winding to an output of the switching converter.

9. An LC snubber circuit as claimed in claim 2, wherein the snubber transformer has subtractive polarity.

10. A switching converter, comprising:
the LC snubber circuit as claimed in claim 9;
a first converter inductor connected between the first connection node and the second connection node; and
a first converter switching device connected between the second connection node and the third connection node, wherein the LC snubber circuit is connected to the first, second and third connection nodes.

11. A switching converter as claimed in claim 10, wherein the switching converter is an isolated switching converter, and the first converter inductor is a primary winding of a main transformer of the switching converter.

12. A switching converter as claimed in claim 11, wherein the isolated switching converter is a flyback converter.
